(19) United States
(12) Patent Application Publication
(10) Pub. No.: US 2026/0155451 A1
(43) Pub. Date: Jun. 4, 2026

(54) ALL-SOLID-STATE BATTERY

(71) Applicant: SAMSUNG ELECTRO-MECHANICS CO., LTD., Suwon-si, Gyeonggi-do (KR)

(72) Inventors: Taehoon Kim, Suwon-si, Gyeonggi-do (KR); Dongwon Kim, Suwon-si, Gyeonggi-do (KR); Myung Jin Jung, Suwon-si, Gyeonggi-do (KR); Jongmin Kim, Suwon-si, Gyeonggi-do (KR); Han Kim, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/692,607

(22) PCT Filed: Dec. 28, 2023
(86) PCT No.: PCT/KR2023/021806

§ 371 Date: Mar. 15, 2024

(30) Foreign Application Priority Data
Oct. 16, 2023 (KR) 10-2023-0137873

(51) Int. Cl. H01M 10/0585; H01M 4/13; H01M 4/587; H01M 4/66; H01M 4/70; H01M 10/0525

(52) U.S. Cl. CPC H01M 10/0585; H01M 4/13; H01M 4/587; H01M 4/661; H01M 4/70; H01M 10/0525

(57) ABSTRACT

The disclosed all-solid-state battery includes a laminate including first and second surfaces facing each other in a first direction, third and fourth surfaces facing each other in a second direction and connecting the first and second surfaces, and fifth and sixth surfaces facing each other in a third direction and connecting the first and second surfaces, and including a solid electrolyte layer and positive and negative electrode layers alternately stacked in the third direction with the solid electrolyte layer interposed therebetween; a first external electrode connected to the positive electrode layer and disposed outside the laminate; and a second external electrode connected to the negative electrode layer and disposed outside the laminate. The positive electrode layer may include a positive electrode current collector including an aluminum foil, the negative electrode layer may include a negative electrode active material including graphite, and the positive electrode current collector may be connected to the first external electrode on the first, third, and fourth surfaces of the laminate.

### TECHNICAL FIELD

The present disclosure relates to an all-solid-state battery.

### BACKGROUND ART

Recently, as portable electronic devices are required to be downsized and used for a long time, high-capacity batteries are required, and with the spread of wearable electronic devices, ensuring the safety of batteries is required.

Lithium-ion batteries currently on the market use electrolytes containing flammable organic solvents, so there is a possibility of overheating and fire in the event of a short circuit. Accordingly, an all-solid-state battery using a solid electrolyte instead of an electrolyte solution has been proposed.

Because the all-solid-state battery does not use a flammable organic solvent, the possibility of fire or explosion in the event of a short circuit may be considerably reduced. Therefore, the all-solid-state batteries may increase safety significantly compared to the lithium ion batteries that use an electrolytic solution.

Because high-temperature sintering is required when forming a positive electrode layer of an oxide-based all-solid-state battery, graphite is often used instead of metal as a positive electrode current collector. A graphite current collector has the problem of low electron conductivity.

### DISCLOSURE OF INVENTION

### Solution to Problem

An aspect of an embodiment is to provide an all-solid-state battery having a positive electrode current collector with high electron conductivity.

However, the object of the present disclosure is not limited to the aforementioned one, and may be extended in various ways within the spirit and scope of the present disclosure.

An embodiment provides an all-solid-state battery including: a laminate including first and second surfaces facing each other in a first direction, third and fourth surfaces facing each other in a second direction and connecting the first and second surfaces, and fifth and sixth surfaces facing each other in a third direction and connecting the first and second surfaces, and including a solid electrolyte layer and positive and negative electrode layers alternately stacked in the third direction with the solid electrolyte layer interposed therebetween; a first external electrode connected to the positive electrode layer and disposed outside the laminate; and a second external electrode connected to the negative electrode layer and disposed outside the laminate, wherein the positive electrode layer may include a positive electrode current collector including an aluminum foil, the negative electrode layer may include a negative electrode active material including graphite, and the positive electrode layer may be connected to the first external electrode on the first, third, and fourth surfaces of the laminate.

In addition, the positive electrode current collector may include a first surface and a second outer surface facing each other in the third direction, and a positive electrode active material may be disposed on at least one of the first outer surface and the second outer surface.

In addition, the positive electrode active material may be disposed on the first outer surface and the second outer surface, respectively.

In addition, the positive electrode active material may be disposed only on the one of the first outer surface and the second outer surface.

In addition, when viewed in the third direction, the positive electrode current collector may include a main body that has a rectangular shape including a first side and a second side facing each other in the first direction and a third side and a fourth side facing each other in the second direction, a first extension that protrudes from the third side of the main body toward the third surface of the laminate, and a second extension that protrudes from the fourth side of the main body toward the fourth surface of the laminate, and the first side of the main body may be in contact with the first surface of the laminate, and the second side of the main body may be spaced apart from the second surface of the laminate.

In addition, the first extension may be in contact with the first and third surfaces of the laminate, and the second extension may be in contact with the first and fourth surfaces of the laminate.

In addition, the all-solid-state battery may further include a first margin portion disposed between the second surface of the laminate and the positive electrode layer.

In addition, the first margin portion may include at least one of a solid electrolyte and an insulating material.

In addition, the solid electrolyte included in the first margin portion may be the same as a solid electrolyte included in the solid electrolyte layer.

In addition, the solid electrolyte included in the first margin portion may be different from a solid electrolyte included in the solid electrolyte layer.

In addition, the negative electrode layer may be connected to the second external electrode on the second surface of the laminate.

In addition, the all-solid-state battery may further include a second margin portion disposed between the first surface of the laminate and the negative electrode layer.

In addition, the second margin portion may include at least one of a solid electrolyte and an insulating material.

In addition, the solid electrolyte included in the second margin portion may be the same as a solid electrolyte included in the solid electrolyte layer.

In addition, the solid electrolyte included in the second margin portion may be different from a solid electrolyte included in the solid electrolyte layer.

In addition, the positive electrode layer may have a shape different from the negative electrode layer.

According to the all-solid-state battery according to the embodiment, the electron conductivity of the positive electrode current collector is high, so high positive electrode characteristics may be realized.

### BRIEF DESCRIPTION OF DRAWINGS

FIG. 1 illustrates a schematic perspective view of an all-solid-state battery according to an embodiment.

FIG. 2 illustrates a cross-sectional view taken along line II-II′ of FIG. 1.

FIG. 3 illustrates a cross-sectional view taken along line III-III′ of FIG. 2.

FIG. 4 illustrates a cross-sectional view taken along line IV-IV′ of FIG. 2.

FIG. 5A to FIG. 5D are drawings schematically illustrating a method of manufacturing a laminate of an all-solid-state battery according to Example 1.

FIG. 6 is a drawing schematically illustrating a laminate according to Example 1.

FIG. 7 is a drawing schematically illustrating a laminate manufactured according to Example 2.

FIG. 8 is a drawing schematically illustrating a laminate manufactured according to a comparative example.

FIG. 9 illustrates a graph of capacity ratios to C-rate of the all-solid batteries manufactured according to Example 1, Example 2, and the comparative example.

### MODE FOR THE INVENTION

The present disclosure will be described more fully hereinafter with reference to the accompanying drawings, in which embodiments of the disclosure are shown. The drawings and description are to be regarded as illustrative in nature and not restrictive. Like reference numerals designate like elements throughout the specification. In addition, some constituent elements are exaggerated, omitted, or briefly illustrated in the added drawings, and sizes of the respective constituent elements do not reflect the actual sizes.

The accompanying drawings are provided only in order to allow embodiments disclosed in the present specification to be easily understood and are not to be interpreted as limiting the spirit disclosed in the present specification, and it is to be understood that the present disclosure includes all modifications, equivalents, and sub-stitutions without departing from the scope and spirit of the present disclosure.

Terms including ordinal numbers such as first, second, and the like will be used only to describe various constituent elements, and are not to be interpreted as limiting these constituent elements. The terms are only used to differentiate one constituent element from other constituent elements.

It will be understood that when an element such as a layer, film, region, area, or substrate is referred to as being “on” or “above” another element, it can be directly on the other element or intervening elements may also be present. In contrast, when an element is referred to as being “directly on” another element, there are no intervening elements present. Further, in the specification, the word “on” or “above” means disposed on or below the object portion, and does not necessarily mean disposed on the upper side of the object portion based on a gravitational direction.

Throughout the specification, it should be understood that the term “include”, “comprise”, “have”, or “configure” indicates that a feature, a number, a step, an operation, a constituent element, a part, or a combination thereof described in the specification is present, but does not exclude a possibility of presence or addition of one or more other features, numbers, steps, operations, constituent elements, parts, or com-binations, in advance. Unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Furthermore, throughout the specification, “connected” does not only mean when two or more elements are directly connected, but also when two or more elements are indirectly connected through other elements, and when they are physically connected or electrically connected, and further, it may be referred to by different names depending on a position or function, and may also be referred to as a case in which respective parts that are substantially integrated are linked to each other.

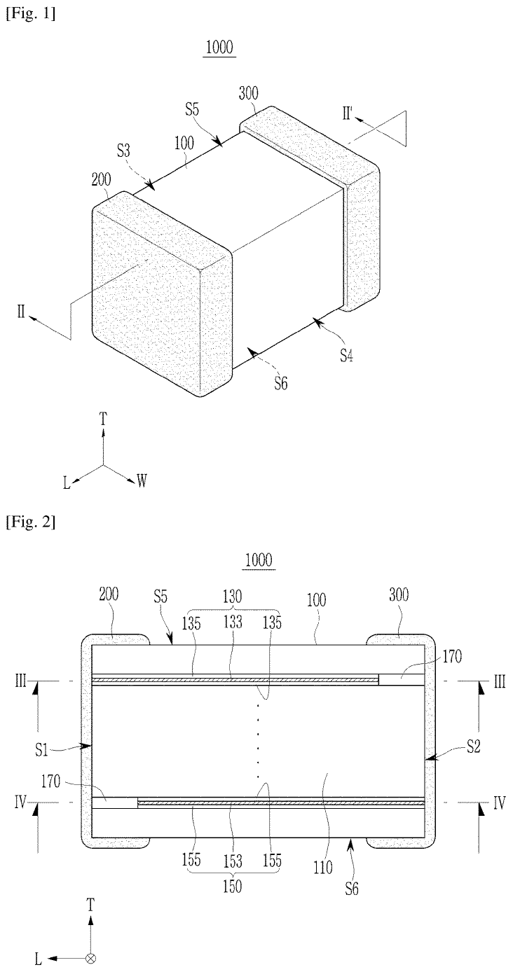

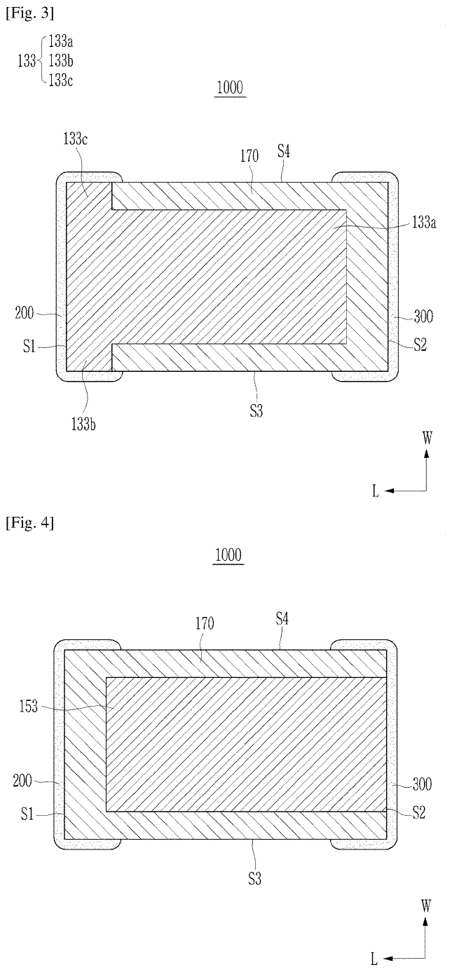

FIG. 1 illustrates a schematic perspective view of an all-solid-state battery according to an embodiment, FIG. 2 illustrates a cross-sectional view taken along line II-II′ of FIG. 1, FIG. 3 illustrates a cross-sectional view taken along line III-III′ of FIG. 2, and FIG. 4 illustrates a cross-sectional view taken along line IV-IV′ of FIG. 2.

Referring to FIG. 1, FIG. 2, FIG. 3, and FIG. 4, an all-solid-state battery 1000 according to the present embodiment includes a laminate 100, a first external electrode 200, and a second external electrode 300.

First, defining directions to clearly describe the present embodiment, an L-axis, a W-axis, and a T-axis shown in the drawings indicate axes respectively representing a length direction, a width direction, and a thickness direction of the all-solid-state battery 1000.

The thickness direction (T-axis direction) may be a direction perpendicular to a wide surface (main surface) of sheet-shaped components. For example, the thickness direction (T-axis direction) may be used as the same concept as a direction in which components of the laminate 100 are stacked.

The length direction (L-axis direction) is a direction parallel to the wide surface (main surface) of the sheet-shaped components, and may be a direction that intersects (or is perpendicular to) the thickness direction (T-axis direction). For example, the length direction (L-axis direction) may be a direction in which the first external electrode 200 and the second external electrode 300 face each other.

The width direction (W-axis direction) is a direction parallel to the wide surface (main surface) of the sheet-shaped components, and may be a direction that simul-taneously intersects (or is perpendicular to) the thickness direction (T-axis direction) and the length direction (L-axis direction).

The laminate 100 may have a substantially hexahedral shape, but the present embodiment is not limited thereto. Due to contraction during sintering, the laminate 100 may have a substantially hexahedral shape, although not a perfect hexahedral shape. For example, the laminate 100 has a substantially cuboidal shape, but corner or vertex portions may have a round shape.

In the present embodiment, for convenience of description, surfaces facing each other in the length direction (L-axis direction) are defined as a first surface S1 and a second surface S2, surfaces facing each other in the width direction (W-axis direction) and connecting the first surface S1 and the second surface S2 are defined as a third surface S3 and a fourth surface S4, and surfaces facing each other in the thickness direction (T-axis direction) and connecting the first surface S1 and the second surface S2 are defined as a fifth surface S5 and a sixth surface S6.

Accordingly, the first direction in which the first surface S1 and the second surface S2 face each other may be the length direction (L-axis direction), and the second direction and the third direction that are perpendicular to the first direction and perpendicular to each other may be the thickness direction (T-axis direction) and the width direction (W-axis direction), or the width direction (W-axis direction) and the thickness direction (T-axis direction), respectively.

A length of the laminate 100 may mean, based on an optical microscope or scanning electron microscope (SEM) photograph of a cross-section in the length direction (L-axis direction)-the thickness direction (T-axis direction) at a center of the width direction (W-axis direction) of the laminate 100, a maximum value of lengths of a plurality of line segments that connect two outermost boundary lines facing each other in the length direction (L-axis direction) of the laminate 100 shown in the above cross-sectional photograph and are parallel to the length direction (L-axis direction). Meanwhile, the length of the laminate 100 may mean a minimum value of lengths of a plurality of line segments that connect two outermost boundary lines facing each other in the length direction (L-axis direction) of the laminate 100 shown in the above cross-sectional photograph and are parallel to the length direction (L-axis direction). On the other hand, the length of the laminate 100 may mean an arithmetic average of lengths of at least two of a plurality of line segments that connect two outermost boundary lines facing each other in the length direction (L-axis direction) of the laminate 100 shown in the above cross-sectional photograph and are parallel to the length direction (L-axis direction).

A thickness of the laminate 100 may mean, based on an optical microscope or scanning electron microscope (microscope SEM) photograph of a cross-section in the length direction (L-axis direction)-the thickness direction (T-axis direction) at a center of the width direction (W-axis direction) of the laminate 100, a maximum value of lengths of a plurality of line segments that connect two outermost boundary lines facing each other in the thickness direction (T-axis direction) of the laminate 100 shown in the above cross-sectional photograph and are parallel to the thickness direction (T-axis direction). Meanwhile, the thickness of the laminate 100 may mean a minimum value of lengths of a plurality of line segments that connect two outermost boundary lines facing each other in the thickness direction (T-axis direction) of the laminate 100 shown in the above cross-sectional photograph and are parallel to the thickness direction (T-axis direction). On the other hand, the thickness of the laminate 100 may mean an arithmetic average of lengths of at least two of a plurality of line segments that connect two outermost boundary lines facing each other in the thickness direction (T-axis direction) of the laminate 100 shown in the above cross-sectional photograph and are parallel to the thickness direction (T-axis direction).

A width of the laminate 100 may mean, based on an optical microscope or scanning electron microscope (microscope SEM) photograph of a cross-section in the length direction (L-axis direction)-the width direction (W-axis direction) at a center of the thickness direction (T-axis direction) of the laminate 100, a maximum value of lengths of a plurality of line segments that connect two outermost boundary lines facing each other in the width direction (W-axis direction) of the laminate 100 shown in the above cross-sectional photograph and are parallel to the width direction (W-axis direction). Meanwhile, the width of the laminate 100 may mean a minimum value of lengths of a plurality of line segments that connect two outermost boundary lines facing each other in the width direction (W-axis direction) of the laminate 100 shown in the above cross-sectional photograph and are parallel to the width direction (W-axis direction). On the other hand, the width of the laminate 100 may mean an arithmetic average of lengths of at least two of a plurality of line segments that connect two outermost boundary lines facing each other in the width direction (W-axis direction) of the laminate 100 shown in the above cross-sectional photograph and are parallel to the width direction (W-axis direction).

The laminate 100 may include a solid electrolyte layer 110, a positive electrode layer 130, a negative electrode layer 150, and a margin portion 170.

The solid electrolyte layer 110, the positive electrode layer 130, and the negative electrode layer 150 are each plural, and the positive electrode layers 130 and the negative electrode layers 150 may be alternately stacked in the thickness direction (T-axis direction) with the solid electrolyte layer 110 interposed therebetween.

The positive electrode layer 130 may be disposed on one surface of the solid electrolyte layer 110, and the negative electrode layer 150 may be disposed on the other surface of the solid electrolyte layer 110.

The solid electrolyte layer 110 includes a solid electrolyte. The solid electrolyte may serve as a channel for lithium (Li) ions.

The solid electrolyte which is contained in the solid electrolyte layer 110 may include a glass-ceramic-based electrolyte including lithium halide (halogen elements such as LiX, X═F, Br, Cl, or I). Glass-ceramic (or crystallized glass) refers to a crystal-lographic mixture of amorphous and crystalline materials from which peaks and halos are observed in X-ray diffraction, electron diffraction, etc. Accordingly, the glass-ceramic-based electrolyte is an electrolyte that has undergone partial crystallization through sintering and in which amorphous and crystalline materials are mixed.

The glass-ceramic-based electrolyte may be a mixture of an amorphous material and two or more types of crystalline materials. Further, the crystalline materials which are contained in the glass-ceramic-based electrolyte may include a lithium-compound crystalline phase containing lithium.

When the glass-ceramic-based electrolyte is included, sufficient densification is achieved after sintering, whereby it is possible to realize high ionic conductivity.

The glass-ceramic-based electrolyte may include a lithium (Li) oxide, a boron (B) oxide, a silicon (Si) oxide, an aluminum (Al) oxide, a gallium (Ga) oxide, a phosphorus (P) oxide, a germanium (Ge) oxide, a magnesium. (Mg) oxide, and a lithium chloride (LiCl). As a specific example, the glass-ceramic-based electrolyte may contain Li₂O—B₂O₃—SiO₂—P₂O₅—GeO₂—LiCl.

On the other hand, the solid electrolyte which is contained in the solid electrolyte layer 110 may include a lithium-borosilicate-based electrolyte (hereinafter, also referred to as an LBSO-based electrolyte). The LBSO-based electrolyte is a glass-state electrolyte, and glass refers to a crystallographically amorphous material from which halos are observed in X-ray diffraction, electron diffraction, etc.

When the LBSO-based electrolyte is included, it is possible to keep the amorphous state during sintering while lowering the sintering temperature. Therefore, there is an advantage that it is possible to realize high ionic conductivity and reactivity with electrodes is not high ionic conductivity. The LBSO-based electrolyte may include lithium (Li), boron (B), silicon (Si), aluminum (Al), phosphorus (P), germanium (Ge), and sulfur(S).

Alternatively, the solid electrolyte which is contained in the solid electrolyte layer 110 may be one or more types selected from a group consisting of a Garnet-type, a Nasicon-type, a LISICON-type, a perovskite-type, and a LiPON-type.

The Garnet-type solid electrolyte may refer to a lithium-lanthanum-zirconium oxide (LLZO) represented by LiₐLa_{b}Zr_{c}O₁₂, such as Li₇La₃Zr₂O₁₂, and the Nasicon-type solid electrolyte may refer to a lithium-aluminum-titanium-phosphate (LATP) Li₁₊ₓAlₓTi₂₋ₓ(PO₄)₃ (wherein 0<x<1) produced by introducing Ti into LAMP Li₁₊ₓAlₓM₂₋ₓ(PO₄)₃ (wherein 0<x<2 and M is Zr, Ti, or Ge) type compound, and a lithium-aluminum-germanium-phosphate (LAGP) represented by Li₁₊ₓAlₓGe₂₋ₓ(PO₄)₃ (wherein (<x<1), such as Li_{1.3}Al_{0.3}Ge_{1.7}(PO₄)₃ containing an excessive amount of lithium and/or lithium-zirconium-phosphate (LZP) LiZr₂(PO₄)₃.

In addition, the LISICON-type solid electrolyte may refer to a solid solution oxide represented by xLi₃AO₄-(1−x)Li₄BO₄ (wherein A is P, As, V, etc., and B is Si, Ge, Ti, etc.) such as Li₄Zn(GeO₄)₄, Li₁₀GeP₂O₁₂(LGPO), Li_{3.5}Si_{0.5}P_{0.5}O₄, Li_{10.42}Si(Ge)_{1.5}P_{1.5}Cl_{0.08}O_{11.92} and the like, and solid solution sulfide represented by Li₄₋ₓM_{1-y}M′_{y}S₄ (wherein M is Si, or Ge and M′is P, Al, Zn, or Ga) such as Li₂S—P₂S₅, Li₂S—SiS₂, Liz₂-SiS₂—P₂S₅, Li₂S—GeS₂ and the like.

In addition, the perovskite-type solid electrolyte may refer to a lithium lanthanum titanate (LLTO) represented by Li₃ₓLa_{2/3-x}□_{1/3-2x} TIO; (wherein 0<x<0.16, and □ is an assumed vacancy content) such as Li_{1/8}La_{5/8}TiO₃, and the LiPON-type solid electrolyte may refer to a nitride such as a lithium-phosphorus-oxynitride such as Li_{2.8}PO_{3.3}N_{0.46} and the like.

The positive electrode layer 130 may be exposed to the first surface S1, the third surface S3, and the fourth surface S4 of the laminate 100, and may be connected to the first external electrode 200.

The positive electrode layer 130 may include a positive electrode current collector 133 and a positive electrode active material layer 135.

The positive electrode current collector 133 may be made of an aluminum (Al) foil. The positive electrode current collector 133 may be, for example, a porous member having a reticular shape, a mesh shape, etc.

Since the surface of the aluminum foil is oxidized, so even when sintered in an air atmosphere at a temperature below 600° C., the oxide film does not increase. Aluminum has high electron conductivity. Therefore, when an aluminum foil is used as a positive electrode current collector of an all-solid-state battery, positive electrode characteristics may be improved.

On the other hand, high-temperature sintering is required to form a positive electrode of an oxide-based all-solid-state battery, so graphite is sometimes used as a positive electrode current collector. Graphite has a problem of being thick and having low electron conductivity (or ionic conductivity). In order to solve this problem, a metal conductive material may be used instead of graphite, but metals other than aluminum may have a problem with reduced electron conductivity due to surface oxidation.

Referring to FIG. 3, the positive electrode current collector 133 may include a main body 133a, a first extension 133b, and a second extension 133c.

The main body 133a has a substantially rectangular shape, and one of two sides facing in the length direction (L-axis direction) contacts the first surface S1 of the laminate 100 and the other side is spaced apart from the second surface S2. On both sides of the main body 133a facing in the width direction (W-axis direction), the portions except for the portions where the first extension 133b and the second extension 133c are disposed are spaced apart from the third surface S3 and the fourth surface S4 of the laminate 100, respectively.

The first extension 133b is a portion that protrudes from the main body 133a toward the third surface S3 of the laminate 100 and has a substantially rectangular shape. The first extension 133b is in contact with the first surface S1 and the third surface S3 of the laminate 100. The first extension 133b is connected to the first external electrode 200 on the first surface S1 and the third surface S3 of the laminate 100.

The second extension 133c is a portion that protrudes from the main body 133a toward the fourth surface S4 of the laminate 100 and has a substantially rectangular shape. The second extension 133c is in contact with the first surface S1 and the fourth surface S4 of the laminate 100. The second extension 133c is connected to the first external electrode 200 on the first surface S1 and the fourth surface S4 of the laminate 100.

As described above, the positive electrode current collector 133 may be connected to the first external electrode 200 on three surfaces of the laminate 100. That is, the main body 133a is connected to the first external electrode 200 on the first surface S1 of the laminate 100, the first extension 133b is connected to the first external electrode 200 on the first surface S1 and the third surface S3, and the second extension 133c is connected to the first external electrode 200 on the first surface S1 and the fourth surface S4. Since the positive electrode current collector 133 is connected to the first external electrode 200 on three surfaces of the laminate 100, the contact area between the first external electrode 200 and the positive electrode current collector 133 increases. Accordingly, electron transfer between the first external electrode 200 and the positive electrode layer 130 may be improved, and the area to be punched may be reduced, thereby improving the process efficiency of the aluminum foil.

The positive electrode active material layer 135 may include a positive electrode active material, and may be disposed on the surface of the positive electrode current collector 133. The positive electrode active material layer 135 may be formed by printing the positive electrode active material on one or both surfaces of the positive electrode current collector 133, but the method of forming the positive electrode active material layer is not limited thereto.

The positive electrode active material included in the positive electrode active material layer 135 may be a material containing lithium (Li) ions. The positive electrode active material may reversibly intercalate deintercalate lithium ions. In other words, the positive electrode active material may include lithium ions and serve to provide the lithium ions to the negative electrode when the all-solid-state battery is being charged. The positive electrode active material may affect the capacity and output of the all-solid-state battery.

The positive electrode active material may be, for example, a compound represented by the following chemical formula: LiₐA_{1-b}M_{b}D₂ (wherein 0.90≤a≤1.8 and 0≤b≤0.5); LiₐE_{1-b}M_{b}O_{2-c}D_{c} (wherein 0.90≤a≤1.8 and 0≤b≤0.5, 0≤c≤0.05); LiE_{2-b}M_{b}O_{4-c}D_{c} (wherein 0≤b≤0.5 and 0≤c≤0.05); LiₐNi_{1-b-c}CO_{b}M_{c}D_{α} (wherein 0.90≤a≤1.8, 0≤b≤0.5, 0≤c≤0.05 and 0≤α≤2); LiₐNi_{1-b-c}Co_{b}M_{c}O_{2-α}X_{α}(wherein 0.90≤a≤1.8, 0≤b>0.5, 0≤c≤0.05 and 0≤α≤2); LiₐNi_{1-b-c}Co_{b}M_{c}O_{2-α}X₂ (wherein 0.90≤a≤1.8, 0≤b≤0.5, 0≤c≤0.05 and 0≤α≤2); LiₐNi_{1-b-c}Mn_{b}M_{c}D_{α} (wherein 0.90≤a≤1.8, 0≤b≤0.5, 0≤c≤0.05 and 0≤α≤2); LiₐNi_{1-b-c}Mn_{b}M_{c}O_{2-α}X_{α} (wherein0.90≤a≤1.8, 0≤b≤0.5, 0≤c≤0.05 and 0<α<2); LiₐNi_{1-b-c}Mn_{b}M_{c}O_{2-α}X₂ (wherein 0.90≤a≤1.8, 0≤b≤0.5, 0≤c≤0.05 and 0≤α≤2); LiₐNi_{b}E_{c}G_{d}O₂ (wherein 0.90≤a≤1.8, 0≤b≤0.9, 0≤c≤0.5 and 0.001≤d≤0.1); LiₐNi_{b}Co_{c}Mn_{d}GₑO₂ (wherein0.90≤a≤1.8, 0≤b≤0.9, 0≤c≤0.5, 0≤d≤0.5 and 0.001≤e≤0.1); LiₐNiG_{b}O₂ (wherein 0.90≤a≤1.8 and 0.001≤b≤0.1); LiₐCoG_{b}O₂ (wherein 0.90≤a≤1.8 and 0.001≤b≤0.1); LiₐMnG_{b}O₂ (wherein 0.90≤a≤1.8 and 0.001≤b≤0.1); LiₐMn₂G_{b}O₄ (wherein 0.90≤a≤1.8 and 0.001≤b≤0.1); QO₂; QS₂; LiQS₂; V₂O₅; LiV₂O₂; LiRO₂; LiNiVO₄; Li_{(3-f)}J₂(PO₄)₃(0≤f≤2); Li_{(3-f)}Fe₂(PO₄)₃ (wherein 0≤f≤2); and LiFePO₄, in the above formula, A is Ni, Co, or Mn; M is Al, Ni, Co, Mn, Cr, Fe, Mg, Sr, V, or a rare-earth element; D is O, F, S, or P; E is Co or Mn; X is F, S, or P; G is Al, Cr, Mn, Fc, Mg, La, Ce, Sr, or V; Q is Ti, Mo or Mn; R is Cr, V, Fe, Sc, or Y; and J is V, Cr, Mn, Co, Ni, or Cu.

The positive electrode active material may also be LiCoO₂, LiMnₓO₂ₓ ((wherein x is 1 or 2), LiNi₁₋ₓMnₓO₂ₓ ((wherein 0<x<1), LiNi_{1-x-y}CoₓMn_{y}O₂ ((wherein 0≤x≤0.5 and 0≤y≤0.5), LiFePO₄, TiS₂, FeS₂, TiS₃, or FeS₃, but is not limited thereto.

The positive electrode active material may optionally include a conductive material and a binder.

The conductive material is not particularly limited as long as it has conductivity without causing chemical changes in the all-solid-state battery 1000. For example, graphite such as natural graphite or artificial graphite; carbon-based materials such as carbon black, acetylene black, Ketjen black, channel black, furnace black, lamp black, and thermal black; conductive fibers such as carbon fibers, metal fibers, etc.; flu-orinated carbon; metal components such as lithium (Li), tin (Sn), aluminum (Al), nickel (Ni), and copper (Cu), and oxides thereof, nitrides thereof, or fluorides thereof; conductive whiskers such as zinc oxide and potassium titanate; conductive metal oxides such as titanium oxide; conductive materials such as polyphenylene derivatives, etc., and so son may be used.

The binder may be used to improve the bonding strength of the active material, the conductive material, etc. Examples of the binder may include polyvinylidene fluoride, polyvinyl alcohol, carboxymethyl cellulose (CMC), starch, hydroxypropyl cellulose, regenerated cellulose, polyvinylpyrrolidone, polytetrafluoroethylene, polyethylene, polypropylene, ethylene-propylene-dien-terpolymer (EPDM), sulfonated EPDM, styrene butadiene rubber, fluorine rubber, and various copolymers, but is not limited thereto.

Meanwhile, the positive electrode layer 130 may further include a solid electrolyte component. The solid electrolyte component may include one or more of the components described above, and may serve as ion conduction channels within the positive electrode layer. Through this, the interface resistance may be reduced.

The negative electrode layer 150 may be exposed from the second surface S2 of the laminate 100, and may be connected to the second external electrode 300.

The negative electrode layer 150 may include a negative electrode current collector 153 and a negative electrode active material layer 155. Meanwhile, the negative electrode layer 150 may not include a negative electrode current collector.

Referring to FIG. 4, the negative electrode current collector 153 may be made of, for example, a plate-shaped member or a thin member. As another example, the negative electrode current collector 153 may be made of a porous member having a reticular shape, a mesh shape, etc.

The negative electrode current collector 153 may be, for example, a porous metal plate made of stainless steel, nickel (Ni), copper (Cu), tin (Sn), aluminum (Al), or an alloy thereof, but is not limited thereto.

Furthermore, the negative electrode current collector 153 may be coated with an oxidation-resistant metal or alloy film to prevent oxidation.

The negative electrode active material layer 155 may include a negative electrode active material, and may be disposed on the surface of the negative electrode current collector 153. The negative electrode active material layer 155 may be formed by printing the negative electrode active material on one or both surfaces of the negative electrode current collector 153, but the method of forming the negative electrode active material layer is not limited thereto.

The negative electrode active material included in the negative electrode active material layer 155 may store lithium ions that move from the positive electrode when the all-solid-state battery is charged, and release the lithium ions to generate electrical energy when the all-solid-state battery is discharged. As the negative electrode active material, a carbon-based material, silicon, a silicon oxide, a silicon-based alloy, a silicon-carbon-based material composite, tin, a tin-based alloy, a tin-carbon composite, a metal oxide, or a combination thereof may be used, and the negative electrode active material may include a lithium metal and/or a lithium metal alloy.

The lithium metal alloy may include lithium and a metal/metalloid that may be alloyed with lithium. For example, the metal/metalloid capable of making an alloy with lithium may be Si, Sn, Al, Ge, Pb, Bi, Sb, Si-AM alloy (wherein AM is an alkali metal, an alkaline earth metal, an element in group 13 to 16, a transition metal, a rare-earth element, or a combination thereof, and does not include Si), Sn-AM alloy (wherein AM is an alkali metal, an alkaline earth metal, an element in group 13 to 16, a transition metal, a transition metal oxide such as lithium titanium oxide (Li₄Ti₅O₁₂), a rare-earth element, or a combination thereof, and does not include Sn), and MnOx (wherein 0<x≤2), etc.

The element AM may be Mg, Ca, Sr, Ba, Ra, Sc, Y, Ti, Zr, Hf, Rf, V, Nb, Ta, Db, Cr, Mo, W, Sg, Tc, Rc, Bh, Fc, Pb, Ru, Os, Hs, Rh, Ir, Pd, Pt, Cu, Ag, Au, Zn, Cd, B, Al, Ga, Sn, In, Tl, Ge, P, As, Bi, S, Se, Te, Po, or a combination thereof.

Further, oxides of the metal/metalloid capable of making an alloy with lithium may be lithium titanium oxide, vanadium oxide, lithium vanadium oxide, SnO₂, SiO, (wherein 0<x<2), or the like. For example, the negative electrode active material may include one or more elements selected from the group consisting of elements in groups 13 to 16 of the periodic table of elements. For example, the negative electrode active material may include one or more elements selected from the group consisting of Si, Gc, and Sn.

The carbon-based material may be crystalline carbon, amorphous carbon, or a mixture thereof. The crystalline carbon may be graphite, such as natural graphite or artificial graphite, which may be amorphous, plate, flake, spherical or fibrous. In addition, the amorphous carbon may be soft carbon (low-temperature calcined carbon) or hard carbon, mesophase pitch carbide, calcined coke, graphene, carbon black, fullerene soot, carbon nanotubes, and carbon fiber, etc., but is not limited thereto.

The silicon may be selected from the group consisting of Si, SiOₓ (wherein 0<x<2, for example, 0.5 to 1.5), Sn, SnO₂, a silicon-containing metal alloy, and a mixture thereof. The silicon-containing metal alloys may include, for example, silicon and one or more of Al, Sn, Ag, Fe, Bi, Mg, Zn, in, Ge, Pb, and Ti.

The negative electrode active material may optionally include a conductive material and a binder.

The conductive material is not particularly limited as long as it has conductivity without causing chemical changes in the all-solid-state battery 1000. For example, graphite such as natural graphite or artificial graphite; carbon-based materials such as carbon black, acetylene black, Ketjen black, channel black, furnace black, lamp black, and thermal black; conductive fibers such as carbon fibers, metal fibers, etc.; flu-orinated carbon; metal components such as lithium (Li), tin (Sn), aluminum (Al), nickel (Ni), and copper (Cu), and oxides thereof, nitrides thereof, or fluorides thereof; conductive whiskers such as zinc oxide and potassium titanate; conductive metal oxides such as titanium oxide; conductive materials such as polyphenylene derivatives, etc., and so on may be used.

The binder may be used to improve the bonding strength of the active material, the conductive material, etc. Examples of the binder may include polyvinylidene fluoride, polyvinyl alcohol, carboxymethyl cellulose (CMC), starch, hydroxypropyl cellulose, regenerated cellulose, polyvinylpyrrolidone, polytetrafluoroethylene, polyethylene, polypropylene, ethylene-propylene-dien-terpolymer (EPDM), sulfonated EPDM, styrene butadiene rubber, fluorine rubber, and various copolymers, but is not limited thereto.

The margin portion 170 fills, for example, a portion other than the positive electrode layer 130 and the negative electrode layer 150 within the surface on which the positive electrode layer 130 or the negative electrode layer 150 is disposed.

The margin portion 170 may be disposed on the outer surface of the laminate 100 to prevent moisture penetration and may serve to prevent damage caused by physical and chemical stress.

Referring to FIG. 3, the margin portion 170 may form the second surface S2, a portion of the third surface S3, and a portion of the fourth surface S4 of the laminate 100. Referring to FIG. 4, the margin portion 170 may form the first surface S1, a portion of the second surface S2, a portion of the third surface S3, and a portion of the fourth surface S4 of the laminate 100.

The margin portion 170 may be disposed to resolve a step between the solid electrolyte layer 110 and the positive electrode layer 130 and a step between the solid electrolyte layer 110 and the negative electrode layer 150. For example, the margin portion 170 may be disposed on the same plane as the positive electrode layer 130 and the negative electrode layer 150. The margin portion 170 may resolve the step between the solid electrolyte layer 110 and the positive electrode layer 130 or the step between the solid electrolyte layer 110 and the negative electrode layer 150. This increases the density between the solid electrolyte layer 110 and the electrode layer, which may prevent interlayer delamination or bending due to sintering during the manufacturing process of the all-solid-state battery.

The margin portion 170 may be made of an insulating material, that is, a material that does not have electronic (ionic) conductivity.

The margin portion 170 may include a ceramic material, for example, alumina (Al₂O₃), aluminum nitride (AlN), beryllium oxide (BeO), boron nitride (BN), silicon (Si), silicon carbide (SiC), silica (SiO₂), silicon nitride (Si₃N₄), gallium arsenide (GaAs), gallium nitride (GaN), barium titanate (BaTiO₃), zirconium dioxide (ZrO₂), mixtures thereof, oxides and/or nitrides of these materials, or any other suitable ceramic material, but is not limited thereto.

Meanwhile, the margin portion 170 may optionally include the above-described solid electrolyte, and may include one or more types of solid electrolyte, but is not limited thereto.

In addition, a material with low ionic conductivity and low electrical conductivity, that is, an insulating material, may be present in the margin portion 170, or a material with ionic conductivity (or electrical conductivity) similar to that of the solid electrolyte may be present in the margin portion 170. For example, when a material having ionic conductivity (or electrical conductivity) similar to that of the solid electrolyte is present in the margin portion, that material may be the same material as the solid electrolyte in other areas, or it may be a different material. As another example, a material having an ionic conductivity (or electrical conductivity) similar to that of the solid electrolyte and an insulating material may coexist in the margin portion.

The first external electrode 200 and the second external electrode 300 are disposed outside the laminate 100 and connected to the laminate 100.

The first external electrode 200 is connected to the positive electrode layer 130 on the first surface S1, the third surface S3, and the fourth surface S4 of the laminate 100. Meanwhile, the first external electrode 200 may be disposed on the first surface S1, the third surface S3, the fourth surface S4, the fifth surface S5, and the sixth surface S6 of the laminate 100.

The second external electrode 300 is connected to the negative electrode layer 150 on the second surface S2 of the laminate 100. Meanwhile, the second external electrode 300 may be disposed on the second surface S2, the third surface S3, the fourth surface S4, the fifth surface S5, and the sixth surface S6 of the laminate 100.

In another embodiment, the first external electrode 200 may be disposed on the first surface S1, the third surface S3, the fourth surface S4, and the fifth surface S5 of the laminate 100, or may be disposed on the first surface S1, the third surface S3, the fourth surface S4, and the sixth surface S6 of the laminate 100. The second external electrode 300 may be disposed on the second surface S2, the third surface S3, the fourth surface S4, and the fifth surface S5, or may be disposed on the second surface S2, the third surface S3, the fourth surface S4, and the sixth surface S6.

The first external electrode 200 and the second external electrode 300 may be formed, for example, by respectively applying a paste containing a conductive metal to the first surface S1 and the second surface S2 of the laminate 100, or may be formed by transferring a dry film of dried conductive paste to the laminate 100 and then sintering it, but the method of forming the first external electrode 200 and the second external electrode 300 is not limited thereto. Meanwhile, the conductive metal may be, for example, one or more of copper (Cu), nickel (Ni), tin (Sn), palladium (Pd), platinum (Pt), gold (Au), silver (Ag), tungsten (W), titanium (Ti), lead (Pb), and an alloy thereof, but is not limited thereto.

The first external electrode 200 and the second external electrode 300 may each be covered with a plating layer (not shown). The plating layer may include at least one selected from the group consisting of copper (Cu), nickel (Ni), tin (Sn), palladium (Pd), platinum (Pt), gold (Au), silver (Ag), tungsten (W), titanium (Ti), lead (Pb), and an alloy thereof, but is not limited thereto. The plating layer may comprise one or more layers.

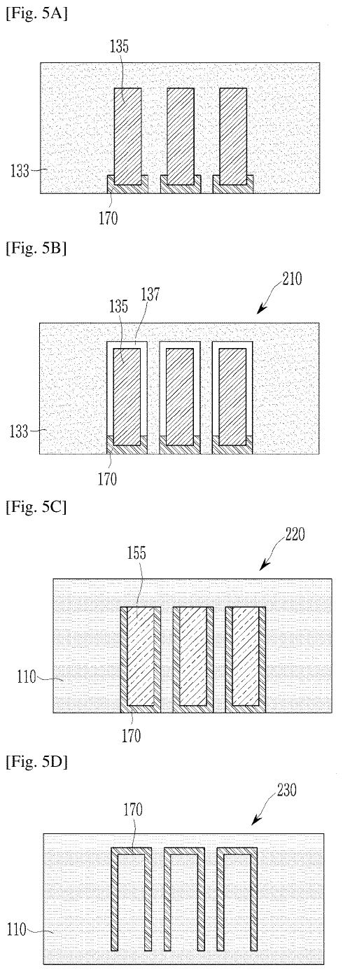

Hereinafter, a method of manufacturing a laminate of an all-solid-state battery according to an embodiment will be described with reference to FIG. 5A to FIG. 5D. FIG. 5A to FIG. 5D are drawings schematically illustrating a method of manufacturing a laminate of an all-solid-state battery according to an embodiment.

A positive electrode active material layer 135 and a margin portion 170 are respectively printed on both surfaces of a sheet for the positive electrode current collector 133 made of an aluminum foil, and then the sheet is punched so that an opening portion 137 surrounding the three side surfaces of the positive electrode active material layer 135 are formed to form the first sheet 210.

A second sheet 220 is formed by printing a negative electrode active material layer 155 and a margin portion 170 on a solid electrolyte layer (green sheet) 110.

A third sheet 230 is formed by printing a margin portion 170 on a solid electrolyte layer (green sheet) 110. Here, the margin portion 170 has a shape corresponding to the opening portion 137 of the first sheet 210.

By repeating the process of stacking the third sheet 230 on the second sheet 220 and then stacking the first sheet 210 on the third sheet 230, a green chip is formed. The green chip is cut to form the laminate 100, and sintered at 400° C. to 550° C. in an air atmosphere.

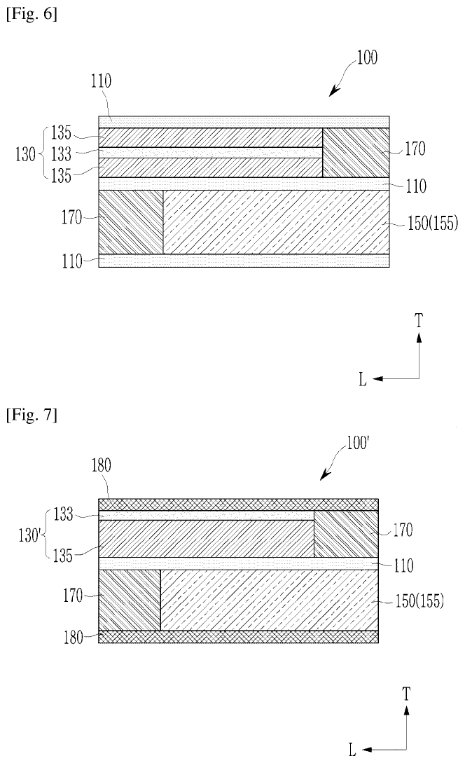

FIG. 6 is a drawing schematically illustrating a laminate according to Example 1.

Referring to FIG. 6, the positive electrode layer 130 of the laminate 100 includes the positive electrode current collector 133 made of aluminum foil, and the positive active material layers 135 disposed on both surfaces in the thickness direction (T-axis direction) of the positive electrode current collector 133. The sum of the thicknesses of the two positive electrode active material layers 135 is 80 μm, and the thickness of the positive electrode current collector 133 is 10 μm. The negative electrode layer 150 includes the negative electrode active material layer 155 that contains graphite. The thickness of the negative electrode layer 150 is 95 μm. The solid electrolyte layer 110 is disposed between the positive electrode layer 130 and the negative electrode layer 150.

FIG. 7 is a drawing schematically illustrating a laminate according to Example 2.

Referring to FIG. 7, the positive electrode active material layer 135 is disposed on only one surface of the thickness direction (T-axis direction) of the positive electrode current collector 133 made of aluminum foil. An insulating layer 180 is disposed on the outer surface of the positive electrode current collector 133. The thickness of the positive electrode active material layer 135 is 70 μm, and the thickness of the positive electrode current collector 133 is 10 μm. The thickness of the negative electrode layer 150 is 80 μm. Another insulating layer 180 is disposed on the outer surface of the negative electrode layer 150. The remaining components except for the above-described components are the same as those of the laminate according to Example 1. Meanwhile, in another embodiment, a solid electrolyte layer may be disposed on the outer surface of the positive electrode current collector 133 and on the outer surface of the negative electrode layer 150. In another embodiment, a material layer in which a solid electrolyte and an insulating material are mixed may be disposed on the outer surface of the positive electrode current collector 133 and on the outer surface of the negative electrode layer 150.

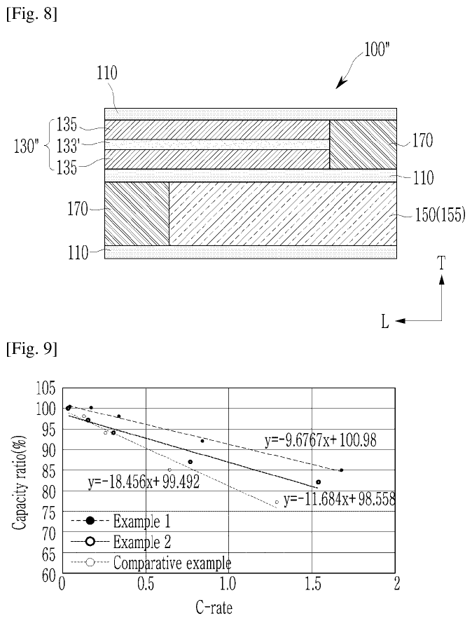

FIG. 8 is a drawing schematically illustrating a laminate according to a comparative example.

Referring to FIG. 8, a positive electrode current collector 133′ is made of graphite. The sum of the thicknesses of two positive electrode active material layers 135 is 60 μm, and the thickness of the positive electrode current collectors 133′ is 5 μm. The thickness of the negative electrode layer 150 is 70 μm. The remaining components except for the above-described components are the same as those of the laminate according to Example 1.

Table 1 shows the thicknesses of the positive electrode layers, the materials and thicknesses of the positive electrode current collectors, and the thicknesses of the negative electrode layers of the all-solid batteries manufactured in Example 1, Example 2, and the comparative example.

TABLE 1

| | | | Comparative |
|---|---|---|---|
| | Example 1 | Example 2 | example |
| Thickness of positive | 80 | 70 | 60 |
| electrode active material | | | |
| layer(s) (μm) | | | |
| Material of positive | Aluminum foil | Aluminum foil | Graphite |
| electrode current | | | |
| collector | | | |
| Thickness of positive | 10 | 10 | 5 |
| electrode current | | | |
| collector (μm) | | | |
| Thickness of negative | 95 | 80 | 70 |
| electrode layer (μm) | | | |

FIG. 9 illustrates a graph of capacity ratios to C-rate of the all-solid batteries manufactured according to Example 1, Example 2, and the comparative example.

Referring to FIG. 9, it can be confirmed that the output characteristics of the all-solid batteries manufactured according to Example 1 and Example 2 are superior to that of the all-solid-state battery manufactured according to the comparative example.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

1000: all-solid-state battery
100, 100′, 100″: laminate
110: solid electrolyte layer
130: positive electrode layer
133: positive electrode current collector
135: positive electrode active material layer
137: opening portion
150: negative electrode layer
153: negative electrode current collector
155: negative electrode active material layer
170: margin portion
180: insulating layer
210: first sheet
220: second sheet
230: third sheet
200: first external electrode
300: second external electrode

1. An all-solid-state battery comprising:
a laminate including first and second surfaces facing each other in a first direction, third and fourth surfaces facing each other in a second direction and connecting the first and second surfaces, and fifth and sixth surfaces facing each other in a third direction and connecting the first and second surfaces, and including a solid electrolyte layer and positive and negative electrode layers alternately stacked in the third direction with the solid electrolyte layer interposed therebetween;
a first external electrode connected to the positive electrode layer and disposed outside the laminate; and
a second external electrode connected to the negative electrode layer and disposed outside the laminate,
wherein the positive electrode layer includes a positive electrode current collector including an aluminum foil,
wherein the negative electrode layer includes a negative electrode active material including graphite, and
wherein the positive electrode layer is connected to the first external electrode on the first, third, and fourth surfaces of the laminate.

2. The all-solid-state battery of claim 1, wherein
the positive electrode current collector includes a first outer surface and
a second outer surface facing each other in the third direction, and
a positive electrode active material is disposed on at least one of the first outer surface and the second outer surface.

3. The all-solid-state battery of claim 2, wherein
the positive electrode active material is disposed on the first outer surface and the second outer surface, respectively.

4. The all-solid-state battery of claim 2, wherein
the positive electrode active material is disposed only on the one of the first outer surface and the second outer surface.

5. The all-solid-state battery of claim 1, wherein
when viewed in the third direction, the positive electrode current collector includes:
a main body that has a rectangular shape including a first side and a second side facing each other in the first direction and a third side and a fourth side facing each other in the second direction,
a first extension that protrudes from the third side of the main body toward the third surface of the laminate, and
a second extension that protrudes from the fourth side of the main body toward the fourth surface of the laminate, and
wherein the first side of the main body is in contact with the first surface of the laminate, and the second side of the main body is spaced apart from the second surface of the laminate.

6. The all-solid-state battery of claim 5, wherein
the first extension is in contact with the first and third surfaces of the laminate, and
the second extension is in contact with the first and fourth surfaces of the laminate.

7. The all-solid-state battery of claim 1, further comprising:
a first margin portion disposed between the second surface of the laminate and the positive electrode layer.

8. The all-solid-state battery of claim 7, wherein
the first margin portion includes at least one of a solid electrolyte and an insulating material.

9. The all-solid-state battery of claim 8, wherein
the solid electrolyte included in the first margin portion is the same as a solid electrolyte included in the solid electrolyte layer.

10. The all-solid-state battery of claim 8, wherein
the solid electrolyte included in the first margin portion is different from a solid electrolyte included in the solid electrolyte layer.

11. The all-solid-state battery of claim 1, wherein
the negative electrode layer is connected to the second external electrode on the second surface of the laminate.

12. The all-solid-state battery of claim 11, further comprising:
a second margin portion disposed between the first surface of the laminate and the negative electrode layer.

13. The all-solid-state battery of claim 12, wherein
the second margin portion includes at least one of a solid electrolyte and an insulating material.

14. The all-solid-state battery of claim 13, wherein
the solid electrolyte included in the second margin portion is the same as a solid electrolyte included in the solid electrolyte layer.

15. The all-solid-state battery of claim 13, wherein
the solid electrolyte included in the second margin portion is different from a solid electrolyte included in the solid electrolyte layer.

16. The all-solid-state battery of claim 1, wherein
the positive electrode layer has a shape different from the negative electrode layer.
